(19) United States
(12) Patent Application Publication
(10) Pub. No.: US 2011/0125675 A1
(43) Pub. Date: May 26, 2011

(54) Method and System for Securitizing Revenue From Transactions That Do Not Involve Credit

(76) Inventors: Donald Ray Cooley, JR., Las Vegas, NV (US); Dhryl Anton, Las Vegas, NV (US)

(21) Appl. No.: 12/860,773

(22) Filed: Aug. 20, 2010

Related U.S. Application Data
(60) Provisional application No. 61/235,631, filed on Aug. 20, 2009.

(51) Int. Cl. G06Q 90/00

(52) U.S. Cl. 705/500

(57) ABSTRACT

An economic system does not involve credit or a determination of the creditworthiness of customers/retail business(es) who conduct transactions. The system includes plural no-credit transactions that produce revenue; and a mechanism for securitization of that revenue. A method of conducting an economy includes the steps of making plural no-credit transactions that produce revenue; and securitizing that revenue.

### CROSS-REFERENCE TO RELATED APPLICATIONS

This application claims priority to U.S. Provisional Patent Application Ser. No. 61/235,631, filed Aug. 20, 2009 and entitled “METHOD AND SYSTEM FOR SECURITIZING REVENUE FROM TRANSACTIONS THAT DO NOT INVOLVE CREDIT”, the disclosure of which is herein incorporated by reference.

### TECHNICAL FIELD

The field of the invention relates to systems and methods for securitizing revenue from transactions.

### SUMMARY OF THE INVENTION

The invention is described in the following paragraphs below and in FIG. 1 which provides a schematic representation of the securitization of a contract that does not involve or use credit. Also accompanying this document is Attachment A, which includes text and drawings, and which discloses various other inventions related to the ones described in the numbered paragraphs below.

Essentially, the inventions of the present application concern a method and system for securitizing revenue from transactions/contracts that do not involve credit, including transactions that do not involve a determination of the creditworthiness of the customer in the transaction (“the no-credit transactions”). The customer in the transaction may be renter/purchaser/user of a product. The product may be any product, including a capital good such as an automobile, washing machine, etc.

By using the related inventions described in the accompanying drawings and Attachment A, certain retail businesses can be set up that generate revenue based upon the no-credit transactions. Those businesses may involve the method and system described in the claims below.

### BRIEF DESCRIPTION OF THE DRAWINGS

FIG. 1 is a schematic representation of a version of the invention, showing the securitization of a contract that does not involve or use credit.

FIG. 2 is a schematic block diagram showing a version of the method of the invention.

FIG. 3 is a schematic block diagram showing another version of the method of the invention.

FIG. 4 is a schematic block diagram showing a version of the system of the invention.

FIG. 5 is a schematic block diagram showing another version of the system of the invention.

FIG. 6 is a schematic block diagram showing another version of the method of the invention.

FIG. 7 is a schematic block diagram showing another version of the system of the invention.

FIG. 8 is an isometric view of a product with a product-control mechanism used with and included in the method and system of the invention.

### DETAILED DESCRIPTION

The present inventions involve using the revenue from retail businesses to make an investment security system wherein the underlying investment securities do not involve credit, or a determination of the creditworthiness of the retail business customer or the retail business upon which the investment security is based. In other words, the investment security system is based upon no-credit transactions.

The novel investment security system includes an investment security instrument, which may also be referred to as “paper,” that is based upon the no-credit transactions.

The term “security” means a contract that is capable of being valued and traded. An investment security is a financial instrument that represents or symbolizes one of three things, namely: (i) ownership (typically in the form of stocks); (ii) a debt agreement (typically in the form of bonds); or (iii) rights to ownership ultimately (typically in the form of derivatives). Securities may include any financial asset, such as the following financial instruments such as stocks, preferred shares, bonds, debentures, futures, options, notes, warrants, or swaps.

A Protected-Asset-Backed-Securities™ (or PABS™) securitization of the revenue stream from the no-credit transactions is possible using any conventional method of securitization of other known revenue streams. The key difference for the present inventions is that the revenue stream is made from the no-credit transactions.

A novel economic system that does not involve credit or a determination of the creditworthiness of the customers/retail business(es) associated with the no-credit transactions includes the revenue from those no-credit transactions, and the securitization of that revenue.

One version of the invention is an economic system that does not involve credit or a determination of the creditworthiness of customers/retail business(es) who conduct transactions. That system includes plural no-credit transactions that produce revenue; and a mechanism for securitization of that revenue.

The invention may also be described as a method of organizing or conducting an economy. That method includes the steps of making plural no-credit transactions that produce revenue; and securitizing that revenue.

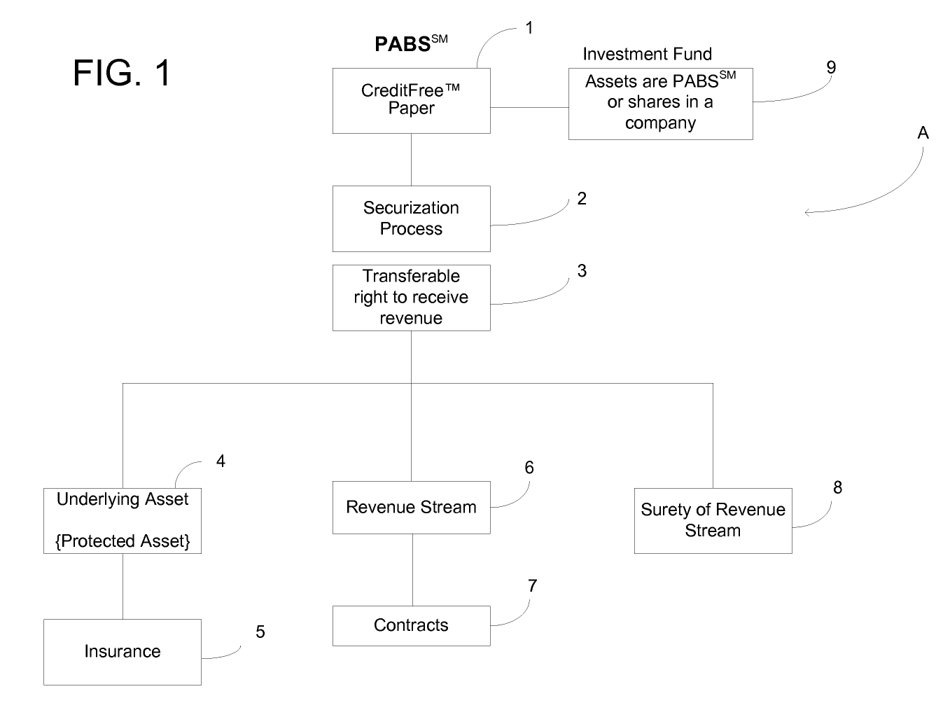

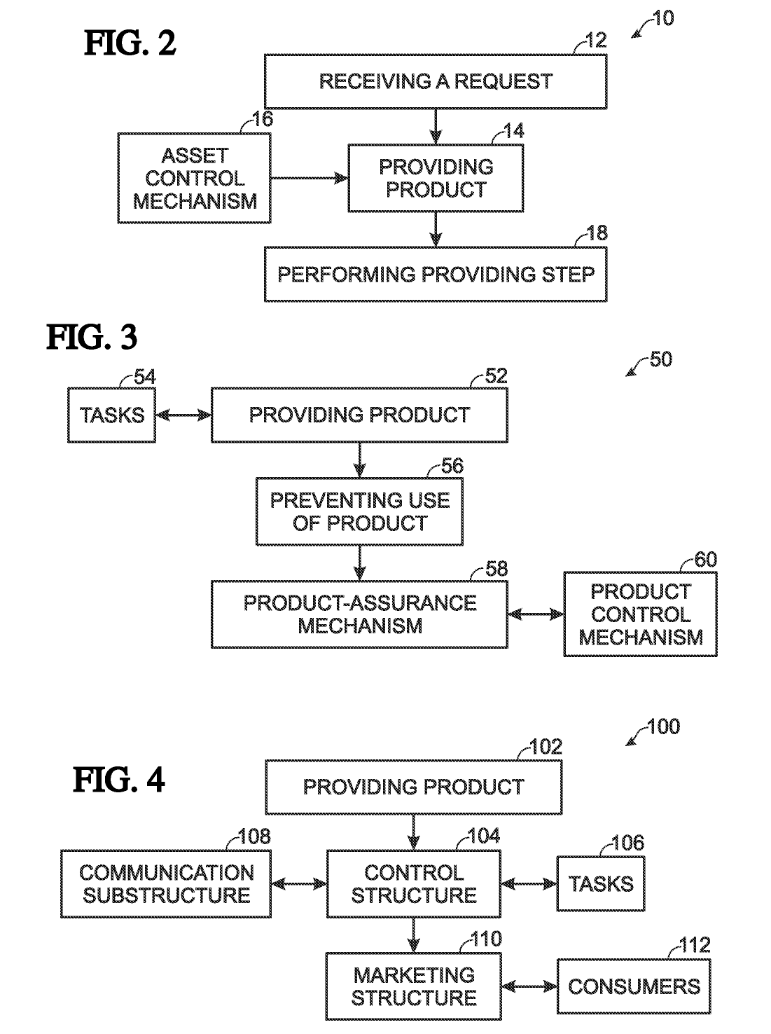

Referring to FIG. 1, the securitization system of the invention is shown generally at A, and includes under the PABS™ heading, a schematic representation of the process, including the making of CREDITFREE™ paper (financial instruments) 1, following a securitization process 2 that includes a transferable right to receive revenue 3. The aspects of the securitization process are shown below box 3, and they include three tracks of activities. One track includes itemizing the underlying (protected) asset (such as the automobile described in connection FIGS. 2-8) as represented by box 4, and insuring the protected asset with a suitable insurance policy, as represented by box 5. The underlying protected asset could be any product, and the automobile described in FIGS. 2-8 is one example of such a product.

A second track includes a revenue stream 6 which is produced from contracts 7 (such as those described in Attachment A for the use of automobiles). A third track includes utilizing a surety of the revenue stream 8.

Still referring to FIG. 1, an investment fund 9 can be established in which either PABS™ securities are sold to investors, or company shares are sold to investors (with the company owning the PABS™ securities).

Referring to FIG. 2, there is shown a method 10 of allowing an owner to permit use of a product by a requestor regardless of creditworthiness. A first step 12 involves receiving a request from a requestor, followed by a second step 14 of providing the product to the requestor. The providing step is done by requiring the requestor to agree to perform preselected tasks required by the owner, and by preventing the requestor from using the product if the requestor does not perform at least one of the preselected tasks. The preselected tasks may include monthly payment obligations to the owner, as well as maintaining product insurance. The idea is for the owner to require tasks that are pertinent to the permitted use of the product.

Still referring to FIG. 2, the preventing step is performed by using an asset-control mechanism 16 that allows the owner to control the product if the requestor does not perform at least one of the preselected tasks. Method 10 also includes step 18 of performing providing step 14 without any regard for the creditworthiness of the requestor.

The asset-control mechanism may include any mechanism that can be controlled remotely or by a timing-control device, and that can be suitably coupled to the product to prevent an individual (such as a requestor, renter, lessee, purchaser) from using it. Suitable coupling of such a mechanism may include coupling to an operational component, such as an actuator, lock mechanism, ignition, motor/engine-related controls, or any other component the disabling of which would render the product useless to the consumer.

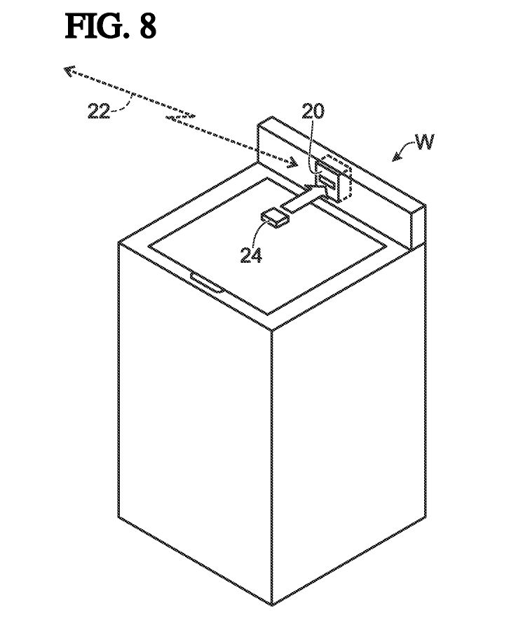

Referring ahead for a moment to FIG. 8, there is shown a product (such as a washing machine) W which includes one version of asset-control mechanism 16 as a control device 20. That control device is constructed to afford two-way communication (shown schematically by the double-arrowed line 22) between the device and the owner of the product. Also shown is portable communication device 24 which may take the form of a card. The idea is for the requestor to possess the card and use it by inserting it into control device 20, allowing the requestor to use product W. The card is one example of several proposed by this invention. Other forms of device 24 (undepicted) may be: (i) a biometric device or other suitable customer identifier (in which the customer presses their thumb on a pad located on control device 20, which is constructed to read the impression of the customer's thumbprint left on the pad and determine whether the customer is an authorized user of product W); or (ii) a keypad device located on and in communication with control device 20, allowing the customer to enter a password/personal-identifier code. By using communication device 24, the invented system and method can verify that the customer is an authorized customer on an ongoing basis. For example, if the customer does not meet a fourth monthly payment obligation after meeting the first three, authorization can be withdrawn immediately and the customer will no longer be able to use the product. The mechanism to accomplish this is to withdraw that customer authorization so that control device 20 will not respond when the customer uses the communication device to begin operating the product. The product owner is in communication with control device 20 via the two-way communication shown by arrow 22.

The idea behind FIG. 8 is to show that asset-control mechanism 16 may be placed in various locations within product W to meet the functional requirements of being suitably coupled to product W so that it can prevent the requestor from using the product. That coupling may take the form of communication with the product-locking system (so that the requestor may not enter), or communication with other operational components of the product (so that the requestor may not operate or use the product).

Referring now to FIG. 3, another version of the invention is shown by a method 50 of assuring that a product is being used by an authorized user. The method includes a step 52 of providing the product to the authorized user. That step is performed by requiring the user to agree to perform at least one preselected task without any regard at any time for the creditworthiness of the user. Another step 56 involves preventing the user from using the product if the user does not perform the at least one preselected task. The concept of tasks is shown schematically at box 54, and those tasks may include payment obligations, product insurance obligations, and others as described above in connection with the first version of the invention.

Still referring to FIG. 3, the preventive step is performed by using product-assurance mechanism 58 and a product-control mechanism 60. Mechanism 58 allows the owner to remotely control the product if the user does not perform the at least one preselected tasks. Mechanism 60 allows the owner to block operation of the product by the requestor. Blocking operation may include locking the product doors so that the user cannot enter, locking the product wheels so that the user cannot drive the product, and disabling the product ignition or other motor/engine-related control mechanism so that the user cannot start or use the product motor/engine.

Referring now to FIG. 4, there is shown a product marketing system 100 that allows a marketer to market products to consumers. System 100 includes a supply 102 of products and control structure 104 coupled to each of the products. A series of tasks shown schematically at 106, and communication substructure 108 are involved with control structure 104 and will be described further after completing this general description. System 100 also includes marketing structure 110 designed to communicate to consumers (shown schematically at 112) about the products and about how a consumer can obtain access to a desired one of the products without regard to the creditworthiness of the consumer.

Still referring to FIG. 4, control structure 104 allows the marketer to control access to a desired product by a consumer. Control structure 104 also allows the marketer to control access to that product based upon whether the consumer performs certain preselected, required tasks 106, such as the tasks defined above. Control structure 104 also includes communications substructure 108 allowing the marketer and consumer to communicate with each other after the consumer has obtained access to the product. That communication may include exchange of any information that is pertinent to the product transaction, including payment by the consumer to the marketer to meet the consumer's monthly payment obligation.

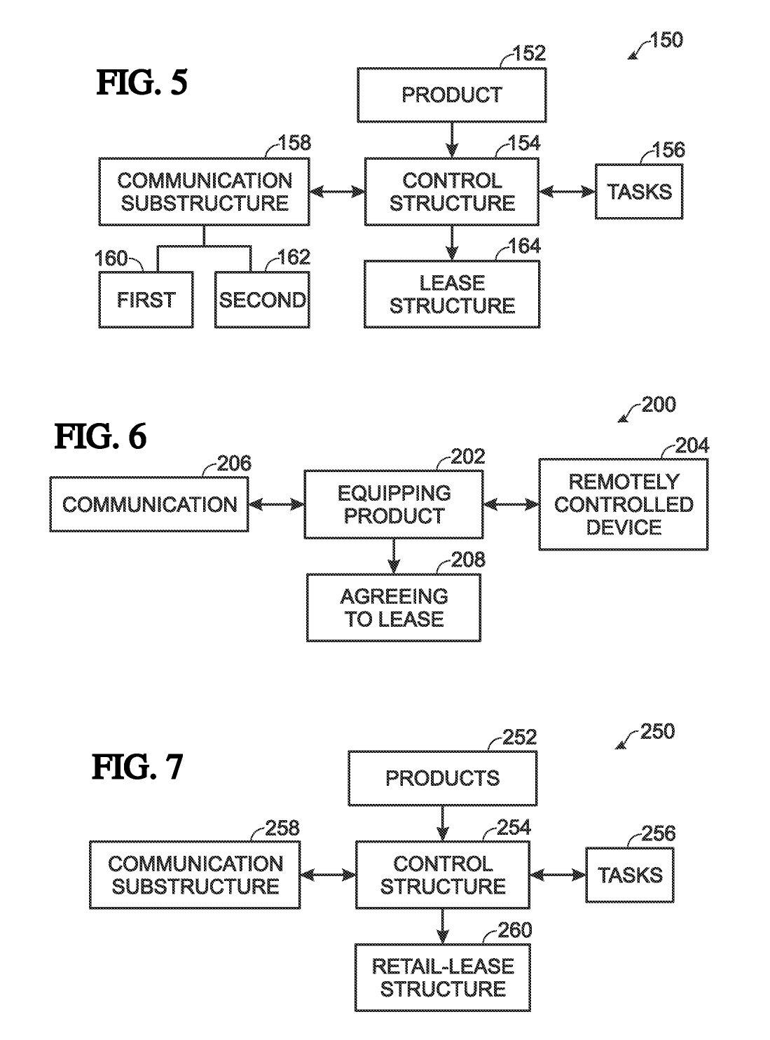

Referring to FIG. 5, the invention may also be characterized as a product lease system 150 that includes a supply 152 of products, and control structure 154 coupled to each of the products. Box 156 schematically illustrates certain tasks to be performed by product lessees, and control structure 154 also includes communication substructure 158. That communication substructure may include first-communication substructure 160 and second-communication substructure 162. First-communication substructure 160 allows the lessor and lessee to communication with each other after the lessee has leased the product. Second-communication substructure 162 allows the lessor to communicate with the product, such as by unlocking the door of the product to enter it.

Still referring to FIG. 5, product lease system 150 also includes lease structure 164 which may take the form of printed or electronic material that defines the lease relationship, and among other things, the number of tasks 156 that the lessee must perform to meet the obligations of lease structure 164.

Referring to FIG. 6, the invention may also be characterized as a method 200 of leasing a product from a lessor to a lessee. That method includes step 202 of equipping a product with a remotely controlled device 204 that can be used to control the product. The concept of communication between the lessor and lessee is shown schematically at box 206, which box is meant to signify that the equipping step also includes use of a communicator to allow the lessor and lessee to communicate with each other after the lessee has leased the product. Method 200 also includes step 208 of agreeing to lease the product to the lessee without regard to the creditworthiness of the lessee.

Referring to FIG. 7, a retail-product leasing system 250 is shown, and includes a supply 252 of products, and control structure 254 coupled to each of the products. Product lessees using the system are required to perform tasks shown schematically at 256, and control structure 254 includes communication substructure 258 to afford communication between the product lessee and lessor about matters pertinent to the product lease, including monthly payment obligations by the lessee.

Still referring to FIG. 7, retail-product leasing system 250 also includes retail-lease structure 260 which may take the form of printed or electronic material that defines the lease relationship, and among other things, the number of tasks 256 that the lessee must perform to meet the obligations of retail-lease structure 260.

The specific embodiments of a method of allowing an owner to permit use of a product by a requestor regardless of creditworthiness as disclosed and illustrated herein are not to be considered in a limiting sense as numerous variations are possible. The subject matter of this disclosure includes all novel and non-obvious combinations and subcombinations of the various features, elements, functions and/or properties disclosed herein. No single feature, function, element or property of the disclosed embodiments is essential. The following claims define certain combinations and subcombinations which are regarded as novel and non-obvious.

We claim:

1. An economic system that does not involve credit or a determination of the creditworthiness of customers/retail business(es) who conduct transactions, comprising:
plural no-credit transactions that produce revenue; and
a mechanism for securitization of that revenue.

2. A method of conducting an economy, comprising:
making plural no-credit transactions that produce revenue; and
securitizing that revenue.
